(19) United States
(12) Patent Application Publication
(10) Pub. No.: US 2024/0018675 A1
(43) Pub. Date: Jan. 18, 2024

(54) CATALYST INCLUDING NICKEL-BASED INTERMETALLIC COMPOUND AND METHOD OF MANUFACTURING THE SAME

(71) Applicants: Hyundai Motor Company, Seoul (KR); Kia Corporation, Seoul (KR); Korea Institute of Science and Technology, Seoul (KR)

(72) Inventors: Dae Yong Son, Seoul (KR); Jong Kil Oh, Yongin (KR); Sung Jong Yoo, Seoul (KR); Ha Neul Jin, Seoul (KR)

(21) Appl. No.: 18/080,463

(22) Filed: Dec. 13, 2022

(30) Foreign Application Priority Data
Jul. 12, 2022 (KR) 10-2022-0085494

(51) Int. Cl. C25B 11/093

(52) U.S. Cl. CPC C25B 11/093

(57) ABSTRACT

Disclosed are a catalyst including a nickel-based intermetallic compound and a method of preparing the same. The catalyst includes a support and a metal component loaded on the support, wherein the metal component includes an intermetallic compound of nickel (Ni) and a noble metal.

### CROSS-REFERENCE TO RELATED APPLICATION

This application claims under 35 U.S.C. § 119(a) the benefit of priority to Korean Patent Application No. 10-2022-0085494, filed on Jul. 12, 2022, the entire contents of which are incorporated herein by reference.

### TECHNICAL FIELD

The present disclosure relates to a catalyst including a nickel-based intermetallic compound and a method of manufacturing the same.

### BACKGROUND

An intermetallic compound refers to a substance in which metal elements constituting an alloy have an ordered structure, so it is thermochemically stable. Generally known intermetallic compounds in noble metal-based alloys are PtCo, PtFe, PdCo, and PdFe based on cobalt (Co) or iron (Fe). However, almost no nickel (Ni)-based intermetallic compounds have been previously known.

Although electrochemical catalysts including intermetallic compounds have been actively developed in recent years, development was slow due to many restrictions on the materials capable of forming intermetallic compounds. In particular, nickel (Ni)-based alloy catalysts are known to have very high activity in electrochemical reactions such as oxygen reduction and hydrogen production, but performance deterioration compared to initial reactivity cannot be avoided due to metal leaching during the reactions. For example, catalysts including nickel (Ni)-based intermetallic compounds are expected to exhibit stable catalytic properties due to the inherent high theoretical thermochemical stability thereof, but they could not be synthesized using a general method.

The above information disclosed in this Background section is only for enhancement of understanding of the background of the invention, and therefore it may contain information that does not form the prior art that is already known in this country to a person of ordinary skill in the art.

### SUMMARY

In preferred aspects, provided are a catalyst including a nickel-based intermetallic compound and a method of manufacturing the same.

The objects of the present disclosure are not limited to those described above. Other objects of the present disclosure will be clearly understood from the following description, and are able to be implemented by means defined in the claims and combinations thereof.

In one aspect, the disclosure provides a catalyst including a support, and a metal component loaded on the support, wherein the metal component may include an intermetallic compound of nickel (Ni) and a noble metal.

The term “metal component” as used herein refers to a compound including at least one metal element (e.g., alkali metals, alkali earth metals, or transition metals) combined with one or more other metals (e.g., alloyable metals) or atoms (e.g., carbon, oxygen, nitrogen, or the like).

The term “noble metal” as used herein refers to a metal element that is resistant to corrosion (e.g., chemical corrosion) and is usually found in nature in its raw form. Exemplary noble metal includes gold, platinum, and the other platinum group metals (ruthenium, rhodium, palladium, osmium, iridium), silver, copper and mercury.

The noble metal may suitably include one or more selected from the group consisting of platinum (Pt), palladium (Pd), iridium (Ir), ruthenium (Ru), gold (Au), silver (Ag), Os (osmium), and rhodium (Rh).

The metal component may include nickel (Ni) and the noble metal in an element ratio of about 4:6 to 6:4. The metal component may have a tetragonal crystal structure.

The term “tetragonal crystal structure” as used herein refers to a cubic lattice having at least one dimension stretched along one of its lattice vectors and it may include orthorhombic crystal structure or system.

The metal component may have a (001) crystal plane.

The metal component may have an average diameter of about 4 nm to 10 nm.

The catalyst may have peaks at 24°±0.5°, 33°±0.5°, 41.5°±0.5°, 47.5°±0.5° and °±0.5° 2θ in an X-ray diffraction (XRD) pattern.

In another aspect, the disclosure provides a method of manufacturing a catalyst including preparing an admixture including a nickel (Ni) precursor, a noble metal precursor, a support, and a reducing agent, applying energy to the admixture to obtain an intermediate including the support and an alloy loaded on the support and including nickel (Ni) and a noble metal, wherein nickel (Ni) and a noble metal are randomly arranged, preparing a mixed powder including the intermediate and urea, and heat-treating the mixed powder to obtain a catalyst including the support and an metal component loaded on the support. The metal component may include an intermetallic compound of nickel (Ni) and the noble metal.

The reducing agent may include one or more selected from the group consisting of oleylamine, ethylene glycol, diethylene glycol, triethylene glycol, tetraethylene glycol, octadecylamine, and hexadecylamine.

The mixed powder may include 100 parts by weight of the intermediate and about 50 to 400 parts by weight of the urea.

The mixed powder may be heat-treated at a temperature greater than about 450° C. and less than about 600° C.

The mixed powder may be heat-treated under a gas atmosphere including not less than about 5% by volume and less than about 10% by volume of hydrogen (H₂) and a balance of inert gas.

The mixed powder may be heat-treated for about 12 to 20 hours.

Also provided is a vehicle including the catalyst as described herein.

Other aspects of the invention are discussed infra.

### BRIEF DESCRIPTION OF THE DRAWINGS

The above and other features of the present disclosure will now be described in detail with reference to certain exemplary embodiments thereof, illustrated in the accompanying drawings which are given hereinbelow by way of illustration only, and thus are not limitative of the present disclosure, and wherein:

FIG. 1 shows the result of transmission electron microscopy (TEM) of the intermediate of Preparation Example according to an exemplary embodiment of the present disclosure;

FIG. 2 shows the result of transmission electron microscopy (TEM) of the catalyst of Preparation Example according to an exemplary embodiment of the present disclosure;

FIG. 3A shows the measured average diameter of the nickel-platinum alloy contained in the intermediate of Preparation Example according to an exemplary embodiment of the present disclosure;

FIG. 3B shows the measured average diameter of the nickel-platinum intermetallic compound contained in the catalyst of Preparation Example according to an exemplary embodiment of the present disclosure;

FIG. 4 shows the result of energy dispersive X-ray spectroscopy (EDS) of the catalyst of Preparation Example according to an exemplary embodiment of the present disclosure;

FIG. 5 shows the result of high resolution transmission electron microscopy of the catalyst of Preparation Example according to an exemplary embodiment of the present disclosure;

FIG. 6A shows the result of X-ray diffraction (XRD) of the catalysts of Experimental Example 1 according to an exemplary embodiment of the present disclosure;

FIG. 6B shows an enlarged view of part A of FIG. 6A;

FIG. 6C shows an enlarged view of part B of FIG. 6A;

FIG. 7A shows the result of X-ray diffraction (XRD) of the catalysts of Experimental Example 2 according to an exemplary embodiment of the present disclosure;

FIG. 7B shows an enlarged view of part A of FIG. 7A;

FIG. 7C shows an enlarged view of part B of FIG. 7A;

FIG. 8A shows the result of X-ray diffraction (XRD) of the catalysts of Experimental Example 3 according to an exemplary embodiment of the present disclosure;

FIG. 8B shows an enlarged view of part A of FIG. 8A; and

FIG. 8C shows an enlarged view of part B of FIG. 8A.

### DETAILED DESCRIPTION

The objects described above, as well as other objects, features and advantages, will be clearly understood from the following preferred embodiments with reference to the attached drawings. However, the present disclosure is not limited to the embodiments and may be embodied in different forms. The embodiments are suggested only to offer a thorough and complete understanding of the disclosed context and to sufficiently inform those skilled in the art of the technical concept of the present disclosure.

Like reference numbers refer to like elements throughout the description of the figures. In the drawings, the sizes of structures may be exaggerated for clarity. It will be understood that, although the terms “first”, “second”, etc. may be used herein to describe various elements, these elements should not be construed as being limited by these terms, which are used only to distinguish one element from another. For example, within the scope defined by the present disclosure, a “first” element may be referred to as a “second” element, and similarly, a “second” element may be referred to as a “first” element. Singular forms are intended to include plural forms as well, unless the context clearly indicates otherwise.

It will be further understood that the terms “comprises” and/or “has”, when used in this specification, specify the presence of stated features, integers, steps, operations, elements, components or combinations thereof, but do not preclude the presence or addition of one or more other features, integers, steps, operations, elements, components, or combinations thereof. In addition, it will be understood that, when an element such as a layer, film, region or substrate is referred to as being “on” another element, it can be directly on the other element, or an intervening element may also be present. It will also be understood that, when an element such as a layer, film, region or substrate is referred to as being “under” another element, it can be directly under the other element, or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all numbers, figures and/or expressions. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, when numerical ranges are disclosed in the description, these ranges are continuous, and include all numbers from the minimum to the maximum, including the maximum within each range, unless defined otherwise. Furthermore, when the range refers to an integer, it includes all integers from the minimum to the maximum, including the maximum within the range, unless otherwise defined. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

The disclosure provides a method capable of relatively simply manufacturing a catalyst including an intermetallic compound of nickel (Ni) and a noble metal, which could not be realized in the related art. The method of manufacturing a catalyst according to the present disclosure may include preparing an admixture including a nickel (Ni) precursor, a noble metal precursor, a support, and a reducing agent, applying energy to the admixture to obtain an intermediate including the support and an alloy loaded on the support and including nickel (Ni) and a noble metal, which are randomly arranged, preparing a mixed powder including the intermediate and urea, and heat-treating the mixed powder to obtain a catalyst including the support and a metal component loaded on the support, wherein the metal component may include an intermetallic compound of nickel (Ni) and the noble metal.

The nickel (Ni) precursor may include a compound including a nickel (Ni) element. For example, the nickel (Ni) precursor may include nickel acetylacetonate (Ni(II) acetylacetonate) or the like.

The noble metal precursor may include a compound including a noble metal. The noble metal may include at least one selected from the group consisting of platinum (Pt), palladium (Pd), iridium (Ir), ruthenium (Ru), gold (Au), silver (Ag), Os (osmium), rhodium (Rh), and combinations thereof, preferably platinum (Pt). The noble metal precursor may include platinum acetylacetonate (Pt (II) acetylacetonate), platinum tetrachloride, tetraamine platinum (II) chloride hydrate, platinum (II) chloride, or the like.

The reducing agent may reduce the nickel (Ni) precursor and the noble metal precursor so that nickel (Ni) and a noble metal can be loaded on the support. Meanwhile, the reducing agent itself may dissolve the nickel (Ni) precursor and the noble metal precursor. The reducing agent may include one or more selected from the group consisting of oleylamine, ethylene glycol, diethylene glycol, triethylene glycol, tetraethylene glycol, octadecylamine, and hexadecylamine.

Any support may be used without limitation as long as it is commonly used in the technical field to which the present disclosure belongs. The support may include a carbon-based material or an oxide-based material such as silica, germanium oxide, titanium oxide, or zirconium oxide.

The amounts of the nickel (Ni) precursor and the noble metal precursor that are added are not particularly limited and the metal component may be weighed and added in order for the metal component to include the nickel (Ni) and noble metal in an element ratio of about 4:6 to 6:4.

The admixture may further include a solvent. As described above, the reducing agent may serve as a solvent, but an additional solvent may be further added. Any solvent commonly used in the technical field to which the present disclosure belongs may be used without limitation as long as it is capable of dissolving the nickel (Ni) precursor and the noble metal precursor, and of dispersing the same without reacting with the support.

The applying energy to the admixture may enable acquisition of an intermediate including the support and an alloy loaded on the support and having a structure in which the nickel (Ni) and the noble metal are randomly arranged thereon.

The process of applying the energy is not particularly limited and any method commonly used in the technical field to which the present disclosure belongs, such as heating the admixture or applying ultrasonic waves to the admixture, may be used without limitation.

When energy is applied to the admixture, the nickel (Ni) precursor and the noble metal precursor may be reduced to form an alloy which is loaded on the support. In this case, the crystal structure of the alloy may be the same as the basic crystal structure of the noble metal. For example, when platinum (Pt) is used as the noble metal, the alloy may have a face-centered cubic crystal structure, which is a basic crystal structure of platinum.

Then, the intermediate may be mixed with urea to prepare a mixed powder. The present disclosure is characterized in that the mixed powder including the intermediate and urea is heat-treated in a gas atmosphere including hydrogen (H₂) at a specific concentration to prepare a catalyst including the intermetallic compound of nickel (Ni) and the noble metal. This will be described later.

The urea as a powder may be mixed with the intermediate. In this case, the mixed powder may include 100 parts by weight of the intermediate and about 50 to 400 parts by weight of the urea. When the content of the urea is less than 50 parts by weight, the formation of the intermetallic compound may be slow and when it exceeds 400 parts by weight, a great amount of urea may be consumed unnecessarily.

The heat-treating the mixed powder may enable acquisition of a catalyst including the support and the metal component that is loaded on the support and including the intermetallic compound of nickel (Ni) and a noble metal.

The mixed powder may be heat-treated under a gas atmosphere including not less than about 5% by volume and less than about 10% by volume of hydrogen (H₂), and a balance of inert gas. The inert gas is not particularly limited and may include argon (Ar) gas. As described above, the intermediate including the alloy of nickel (Ni) and the noble metal may be mixed with urea and the mixed powder is heat-treated in a gas atmosphere including a predetermined concentration of hydrogen (H₂) to prepare a catalyst including the intermetallic compound of nickel (Ni) and the noble metal. Particularly, molecules such as NH₃ and HNCO including nitrogen (N) generated during the heat-treatment of urea induce the formation of intermetallic compounds, and the hydrogen (H₂) gas removes nitrogen (N) in the crystal structure to form an intermetallic compound.

The mixed powder may be heat-treated at a temperature of higher than about 450° C. and lower than about 600° C. for about 12 to 20 hours. When the temperature and time of the heat treatment fall within the ranges defined above, an intermetallic compound of nickel (Ni) and a noble metal can be formed.

### EXAMPLE

Hereinafter, the present disclosure will be described in more detail with reference to the following examples. However, these examples are provided only for better understanding of the present disclosure and thus should not be construed as limiting the scope of the present disclosure.

### Preparation Example

Nickel acetylacetonate (Ni (II) acetylacetonate), platinum acetylacetonate (Pt (II) acetylacetonate), oleylamine and a carbon support were added to a 100 ml round bottom flask to prepare an admixture.

The admixture was stirred in an oil bath at 800 rpm and at a temperature of 100° C. and purged with dry argon gas for about 10 minutes. The result was heated to about 260° C. at a rate at 10° C./min and then the temperature was maintained for about 1 hour to prepare a solution including an intermediate. The solution was cooled to room temperature, washed with toluene/ethanol, and centrifuged to collect the precipitated intermediate. The intermediate was dried in an oven at a temperature of about 60° C.

The intermediate was mixed with an appropriate amount of urea and then pulverized to prepare a mixed powder.

The mixed powder was added to a mother-of-pearl boat and the boat was placed in a tube furnace. The mixed powder was heat-treated at a temperature of 500° C. for 20 hours in a gas atmosphere containing 5 vol % of hydrogen (H₂) and the balance of argon (Ar) to prepare a catalyst in which an intermetallic compound of nickel (Ni) and platinum (Pt) is supported on a support.

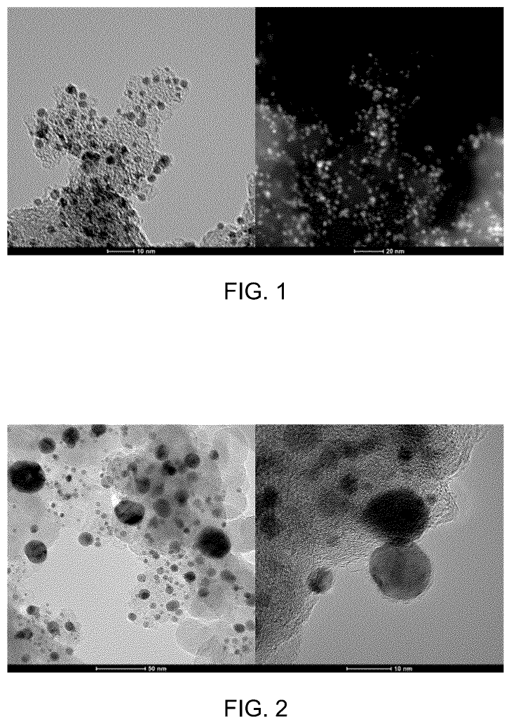

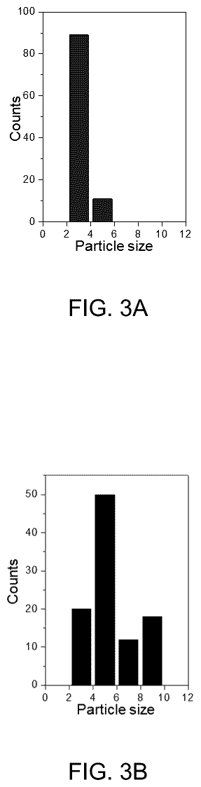

FIG. 1 shows the result of transmission electron microscopy (TEM) of the intermediate of Preparation Example. FIG. 2 shows the result of transmission electron microscopy (TEM) of the catalyst of Preparation Example. FIG. 3A shows the measured average diameter of the nickel-platinum alloy contained in the intermediate of Preparation Example. FIG. 3B shows the measured average diameter of the nickel-platinum intermetallic compound contained in the catalyst of Preparation Example. As shown in FIGS. 3A and 3B, the catalyst had a structure in which the metal component was evenly distributed on the support and the average diameter of the metal component falls within the range of 4 nm to 10 nm.

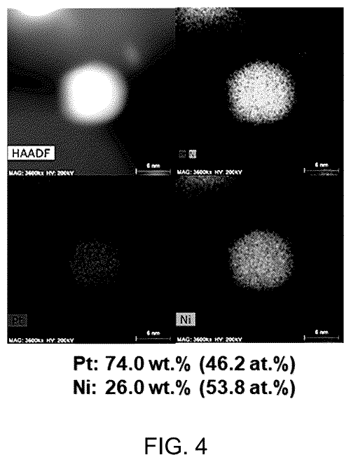

FIG. 4 shows the result of energy dispersive X-ray spectroscopy (EDS) of the catalyst of Preparation Example. As shown in FIG. 4, nickel (Ni) and platinum (Pt) were evenly distributed in the metal component and the metal component contained nickel (Ni) and platinum (Pt) in an element ratio of 5.38:4.62.

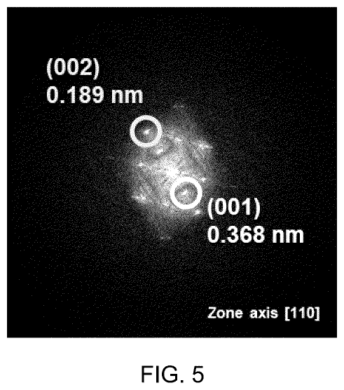

FIG. 5 shows the result of high resolution transmission electron microscopy of the catalyst of Preparation Example. The fast Fourier transform pattern of the metal component showed that the metal component has a (001) crystal plane (0.368 nm) which was not observed in an alloy in which constituent elements were randomly arranged.

### Experimental Example 1—Heat Treatment Temperature

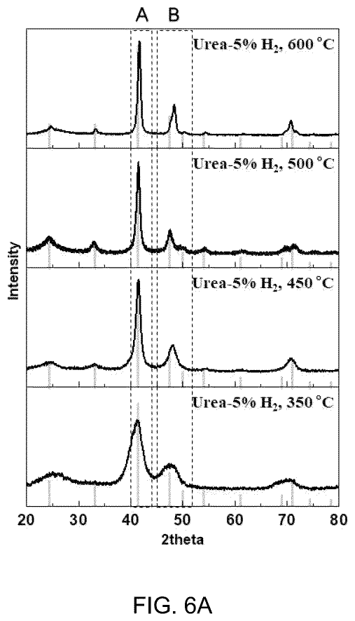

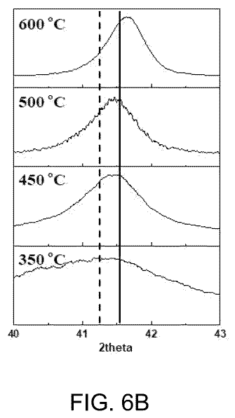

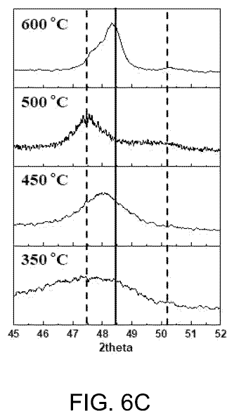

Catalysts were prepared by changing the heat treatment temperature of the mixed powder to 350° C., 450° C., and 600° C., unlike in Preparation Example (500° C.). FIG. 6A shows the result of X-ray diffraction (XRD) analysis of the catalysts of Experimental Example 1. FIG. 6B is an enlarged view of part A of FIG. 6A. FIG. 6C is an enlarged view of part B of FIG. 6A. In FIGS. 6B and 6C, the solid line represents 20 of the peak found in an alloy in which nickel and platinum were randomly arranged, and the dotted line represents 20 of the peak found in an intermetallic compound in which nickel and platinum are regularly arranged.

As shown in FIG. 6A, the catalyst according to Preparation Example (500° C.) has a face-centered cubic crystal structure, which is the basic crystal structure of platinum and the peak in the crystal plane that occurs in a regular structure of the intermetallic compound was observed at 20=24°±0.5° and 33°±0.5°. Meanwhile, as can be seen from FIGS. 6B and 6C, Preparation Example (500° C.) was found at 41.5°±0.5°, 47.5°±0.5° and 50°±0.5° 2θ. On the other hand, when heat treatment was performed at 350° C. and 450° C., no peak was observed at 47.5°±0.5° and 50°±0.5° 2θ, and when heat treatment was performed at a temperature of 600° C., no peak was observed at 41.5°±0.5°. Therefore, the metal component containing the intermetallic compound of nickel and platinum can be prepared only when the mixed powder containing the intermediate and urea is heat-treated at a temperature of more than 450° C. and less than 600° C.

### Experimental Example 2—Heat Treatment Atmosphere

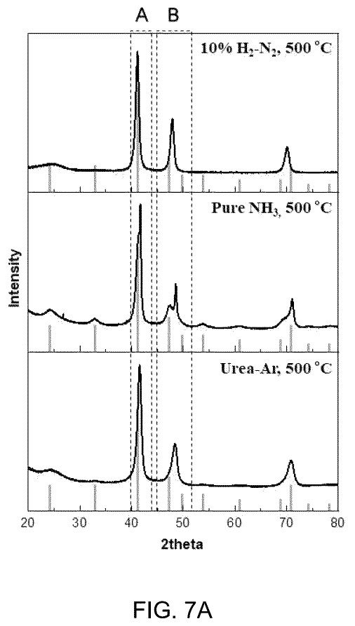

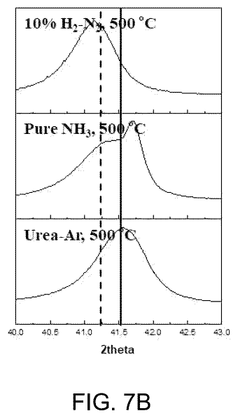

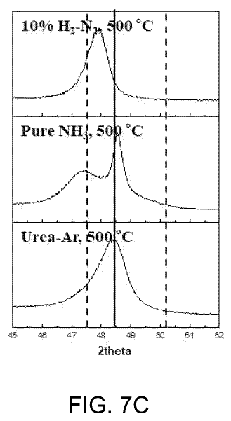

Catalysts were prepared by changing the heat treatment atmosphere of the mixed powder. The catalysts were prepared by increasing the volume of hydrogen to 10% by volume and using nitrogen, ammonia gas, and a mixture of gaseous urea and argon gas as an inert gas. FIG. 7A shows the result of X-ray diffraction (XRD) analysis of the catalysts of Experimental Example 2. FIG. 7B is an enlarged view of part A of FIG. 7A. FIG. 7C is an enlarged view of part B of FIG. 7A.

When the volume of hydrogen was increased to 10% by volume, and nitrogen, or a mixture of gaseous urea and argon gas was used as an inert gas, only the peak corresponding to the alloy was observed. Meanwhile, when ammonia gas was used, the peak corresponding to the alloy and the peak corresponding to the intermetallic compound coexisted. Therefore, the mixed powder containing the intermediate and urea should be heat-treated in a gas atmosphere containing not less than 5% by volume and less than 10% by volume of hydrogen (H₂) and the balance of inert gas so as to prepare an metal component containing an intermetallic compound of nickel and platinum.

### Experimental Example 3—Heat Treatment Time

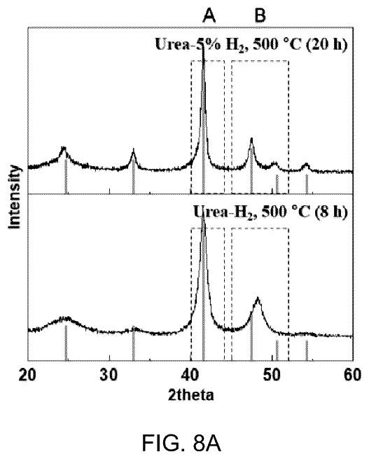

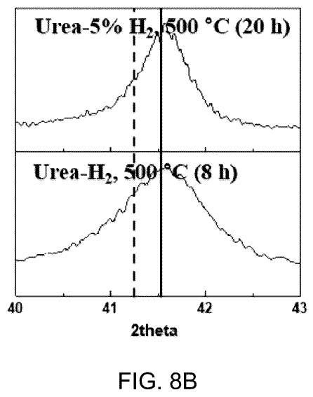

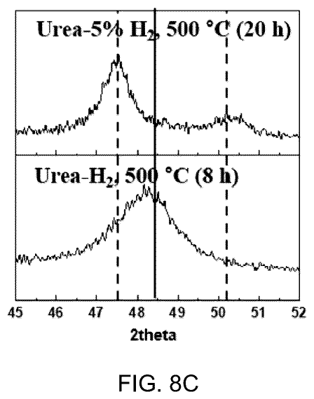

A catalyst was prepared by reducing the heat treatment time of the mixed powder to 8 hours. FIG. 8A shows the result of X-ray diffraction (XRD) analysis of the catalysts of Experimental Example 3, FIG. 8B is an enlarged view of part A of FIG. 8A and FIG. 8C is an enlarged view of part B of FIG. 8A.

When the heat treatment time was 8 hours, no peaks corresponding to intermetallic compounds were observed at 47.5°±0.5° and 50°±0.5° 2θ, but only peaks corresponding to the alloys were observed. Therefore, the mixed powder containing the intermediate and urea should be heat-treated at a temperature of more than 450° C. and less than 600° C. for 8 hours or longer, or 12 to 20 hours in order to prepare an metal component containing an intermetallic compound of nickel and platinum.

The catalyst according to various exemplary embodiments of the present disclosure can be used in electrodes of electrochemical cells, for example batteries, fuel cells or electrolytic cells. For example, the catalyst can be used for electrodes of proton exchange membrane fuel cells (PEMFCs), direct methanol fuel cells (DMFCs), direct ethanol fuel cells (DEFCs) and the like. The fuel cell is applied to generate local energy, e.g., in household fuel cell systems and/or vehicles, e.g., in automobiles. The fuel cell is particularly preferably used for PEMFCs.

Although the present disclosure has been described in detail with reference to experimental examples and examples, these examples should not be construed as limiting the scope of the present disclosure and it will be appreciated by those skilled in the art that changes may be made in these examples without departing from the principles and spirit of the present disclosure, the scope of which is defined in the appended claims and their equivalents.

What is claimed is:

1. A catalyst comprising:
a support; and
a metal component loaded on the support,
wherein the metal component comprises an intermetallic compound of nickel (Ni) and a noble metal.

2. The catalyst according to claim 1, wherein the noble metal comprises one or more selected from the group consisting of platinum (Pt), palladium (Pd), iridium (Ir), ruthenium (Ru), gold (Au), silver (Ag), Os (osmium), and rhodium (Rh).

3. The catalyst according to claim 1, wherein the metal component comprises the nickel (Ni) and the noble metal in an element ratio of about 4:6 to 6:4.

4. The catalyst according to claim 1, wherein the metal component has a tetragonal crystal structure.

5. The catalyst according to claim 1, wherein the metal component has a (001) crystal plane.

6. The catalyst according to claim 1, wherein the metal component has an average diameter of about 4 nm to 10 nm.

7. The catalyst according to claim 1, wherein the catalyst has peaks at 24°±0.5°, 33°±0.5°, 41.5°±0.5°, 47.5°±0.5° and 50°±0.5° 2θ in an X-ray diffraction (XRD) pattern.

8. A method of manufacturing a catalyst, comprising:
preparing an admixture comprising a nickel (Ni) precursor, a noble metal precursor, a support, and a reducing agent;
applying energy to the admixture to obtain an intermediate comprising the support and an alloy loaded on the support and comprising nickel (Ni) and a noble metal, wherein nickel (Ni) and the noble metal are randomly arranged;
preparing a mixed powder comprising the intermediate and urea; and
heat-treating the mixed powder to obtain a catalyst comprising the support and a metal component loaded on the support,
wherein the metal component comprises an intermetallic compound of nickel (Ni) and the noble metal.

9. The method according to claim 8, wherein the reducing agent comprises one or more selected from the group consisting of oleylamine, ethylene glycol, diethylene glycol, triethylene glycol, tetraethylene glycol, octadecylamine, and hexadecylamine.

10. The method according to claim 8, wherein the mixed powder comprises 100 parts by weight of the intermediate and about 50 to 400 parts by weight of the urea.

11. The method according to claim 8, wherein the mixed powder is heat-treated at a temperature higher than about 450° C. and lower than about 600° C.

12. The method according to claim 8, wherein the mixed powder is heat-treated under a gas atmosphere comprising not less than about 5% by volume and less than about 10% by volume of hydrogen (H₂) and a balance of inert gas.

13. The method according to claim 8, wherein the mixed powder is heat-treated for about 12 to 20 hours.

14. The method according to claim 8, wherein the mixed powder is heat-treated at a temperature higher than about 450° C. and lower than about 600° C. under a gas atmosphere comprising not less than about 5% by volume and less than about 10% by volume of hydrogen (H₂), and a balance of inert gas for about 12 to 20 hours.

15. The method according to claim 8, wherein the noble metal comprises one or more selected from the group consisting of platinum (Pt), palladium (Pd), iridium (Ir), ruthenium (Ru), gold (Au), silver (Ag), Os (osmium), and rhodium (Rh).

16. The method according to claim 8, wherein the metal component comprises nickel (Ni) and the noble metal in an element ratio of about 4:6 to 6:4.

17. The method according to claim 8, wherein the metal component has a tetragonal crystal structure.

18. The method according to claim 8, wherein the metal component has a (001) crystal plane.

19. The method according to claim 8, wherein the metal component has an average diameter of about 4 nm to 10 nm.

20. The method according to claim 8, wherein the catalyst has peaks at 24°±0.5°, 33°±0.5°, 41.5°±0.5°, 47.5°±0.5° and 50°±0.5° 2θ in an X-ray diffraction (XRD) pattern.
